(19) United States
(12) Patent Application Publication
(10) Pub. No.: US 2009/0026807 A1
(43) Pub. Date: Jan. 29, 2009

(54) Energy-Absorbing Vehicle Hood Assembly with Cushion Inner Structure

(75) Inventors: Jenne-Tai Wang, Rochester, MI (US); Bing Deng, Rochester Hills, MI (US); Qing Zhou, Beijing (CN); Qi Liu, Beijing (CN); Yong XIA, Beijing (CN)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/782,252

(22) Filed: Jul. 24, 2007

(51) Int. Cl. B62D 25/10

(52) U.S. Cl. 296/193.11

(57) ABSTRACT

An energy-absorbing hood assembly for a vehicle includes an upper layer having a plurality of polyhedral protuberances extending outward therefrom, and preferably a lower layer. The protuberances are disposed between the upper and lower layers, and preferably arranged in longitudinal and transverse rows. The polyhedral protuberances are adapted to absorb and attenuate crush loads imparted to the hood assembly and resultant forces imparted to an object resulting from an impact between the object and the hood assembly. The polyhedral protuberances define various structural and material characteristics along different regions of the hood assembly that are selectively configured to provide different levels of absorption and attenuation of the crush loads and resultant forces. The lower layer is preferably configured to controllably fail at a first predetermined threshold crush load and the polyhedral protuberances are each configured to controllably deform at a second predetermined threshold crush load.

### TECHNICAL FIELD

The present invention relates generally to vehicle front structures, and more particularly to energy-absorbing engine compartment hoods for reducing force and acceleration transmitted to an object by the engine compartment hood upon impact therebetween, while minimizing the stopping distance of the object.

### BACKGROUND OF THE INVENTION

Automotive vehicle bodies are typically constructed using stamped metal panels, which combine substantial overall strength and stiffness with a smooth, paintable exterior surface. With specific regards to vehicle hood panels (also referred to in the art as engine compartment hoods or bonnet structures), panel stiffness is often satisfied via the combination of a relatively high strength stamped metal outer or upper surface, referred to as an “A-surface”, coupled with a preformed inner or lower surface, referred to as a “B-surface”, supported by a series of engine-side or hat-section reinforcements. The hat-section reinforcements are typically positioned between the A- and B-surfaces of the hood, and include a pair of upper flanges oriented toward the A-surface as well as a single lower flange oriented toward the B-surface, with the upper and lower flanges interconnected by a web portion. This conventional hood construction increases the bending stiffness of the hood by placing relatively stiff material, usually stamped steel, as far away as possible from the neutral axis of bending of the hood.

In certain vehicle impact scenarios, an object may exert a downward force on the vehicle hood. Typically, vehicle hoods are deformable when a downward force is exerted thereto. However, the deformability of the hood and, correspondingly, the hood's ability to absorb energy may be impeded by the proximity of the hood to rigidly mounted components housed in the vehicle's engine (or forward) compartment. By way of example, the hood's ability to absorb energy through deformation can be significantly impeded where the hood and engine block are in close proximity. However, minimal clearance between the vehicle hood and the engine compartment components may provide significant benefits, such as improved driver visibility, increased aerodynamics, and aesthetic appeal.

In contrast, additional clearance between the vehicle hood and engine compartment can increase the hood's ability to absorb energy when acted upon with a downward force. Therefore, notwithstanding other design concerns, it can also be advantageous to increase the clearance between the vehicle hood and engine compartment components in the frontward and rearward areas of the vehicle hood.

### SUMMARY OF THE INVENTION

An energy-absorbing vehicle hood assembly having a cushion inner structure attached thereto is provided, offering improved crush performance and more uniform kinetic energy absorption. The vehicle hood assembly and cushion structure also provides high bending stiffness, enabling sufficient rigidity and stability when the vehicle is in normal operation, rendering the hood assembly resistant to flutter or shake dynamics that may occur at high vehicle speeds, and sufficiently resilient to meet “palm load” and “hard spot” requirements. In addition, the improved and more uniform crush characteristics of the energy-absorbing vehicle hood assembly ensure a compliant surface when subjected to a crush load upon impact with a foreign object. As such, the hood assembly is able to maximize its ability to absorb and attenuate kinetic energy imparted thereto, and thereby minimize the required stopping distance of the object.

According to one aspect of the present invention, an energy-absorbing hood assembly is provided for use with a motorized vehicle having a front compartment adapted to house under-hood components. The hood assembly is configured to extend over and above the front compartment, and includes an upper layer having substantially opposing first and second surfaces. The hood assembly also includes a plurality of polyhedral protuberances attached, secured, or adhered to and extending from the second surface of the upper layer. As used herein, the term “polyhedral” is used to define a three-dimensional geometric figure bounded on substantially all sides by polygon faces. The polyhedral protuberances are adapted to absorb and attenuate crush loads imparted to the hood assembly resulting from an impact between an object and the hood assembly. The polyhedral protuberances are also adapted to absorb and attenuate resultant forces imparted to the object by under-hood components as a result of impact between the object and the hood assembly.

The hood assembly preferably includes a lower layer having substantially opposing third and fourth surfaces, wherein the polyhedral protuberances are disposed between the second surface of the upper layer and the third surface of the lower layer. A hood outer panel can also be included, wherein the first surface of the upper layer is attached, secured, or adhered to an interior surface of the hood outer panel. It is further preferred that the polyhedral protuberances are arranged in a plurality of longitudinal and transverse rows.

In another aspect of the invention, the plurality of polyhedral protuberances defines a first set of structural and material characteristics along a first region of the hood assembly. In a similar regard, it is preferred that the polyhedral protuberances also define a second set of structural and material characteristics along a second region of the hood assembly that is different from the first region. It is even further preferred that the plurality of polyhedral protuberances also defines a set of variable structural and material characteristics along a third region of the hood assembly, to form a transition region between the first and second regions. The various sets of structural and material characteristics are selectively configured to provide different predetermined levels of absorption and attenuation of the aforementioned resultant forces and crush loads.

In another aspect of the invention, the lower layer is configured to controllably fail at a first predetermined threshold crush load imparted to the hood assembly by the object upon impact therebetween. The lower layer can be configured to controllably fail at the first predetermined threshold crush load via the addition of precuts or inclusions thereto. In addition or alternatively, the polyhedral protuberances are configured to controllably deform at a second predetermined threshold crush load imparted to the hood assembly by the object upon impact therebetween. The plurality of polyhedral protuberances can be configured to controllably deform at the second predetermined threshold crush load via the addition of precuts or inclusions thereto.

The plurality of protuberances can take on a variety of polyhedral configurations, including, but not limited to, a decahedral configuration, a hexahedral configuration, and a rectangular-celled honeycomb configuration. Ideally, the upper layer, lower layer, and polyhedral protuberances are each made from rubber padding, a metallic material, a brittle plastic, a high-temperature, high-performance polymer foam, or any combination thereof.

In yet another aspect of the invention, the polyhedral protuberances preferably extend substantially perpendicular from the second surface of the upper layer. Alternatively, the protuberances can extend in a substantially acute oblique orientation or a substantially obtuse oblique orientation from the second surface of the upper layer.

According to yet another aspect of the invention, a hood assembly for use with a motorized vehicle is provided. The hood assembly is composed of an upper layer including substantially opposing first and second surfaces, the second surface having a plurality of polyhedral protuberances extending outward therefrom. The hood assembly also includes a lower layer having substantially opposing third and fourth surfaces, wherein the plurality of polyhedral protuberances are disposed between the second and third surfaces, arranged in at least one longitudinal and at least one transverse row. The lower layer is configured to controllably fail at a first predetermined threshold crush load imparted to the hood assembly by an object upon impact therebetween. Additionally, the plurality of polyhedral protuberances are each configured to controllably deform at a second predetermined threshold crush load imparted to the hood assembly by the object upon impact therebetween.

According to yet another aspect of the invention, a vehicle is provided having a vehicle body defining a front compartment. The vehicle also includes a hood assembly configured to extend over and above the front compartment of the vehicle. The hood assembly is composed of an upper layer having substantially opposing first and second surfaces, a lower layer having substantially opposing third and fourth surfaces, and a plurality of polyhedral protuberances operatively attached to and extending from the second surface of the upper layer, and disposed between the second and third surfaces. The polyhedral protuberances define first and second sets of structural and material characteristics along respective first and second regions of the hood assembly. The first and second sets of structural and material characteristics are each selectively configured to provide different predetermined levels of absorption and attenuation of kinetic energy imparted to the hood assembly by an object upon impact therebetween.

The above features and advantages, and other features and advantages of the present invention will be readily apparent from the following detailed description of the preferred embodiments and best modes for carrying out the present invention when taken in connection with the accompanying drawings.

### BRIEF DESCRIPTION OF THE DRAWINGS

FIG. 1 is a plan perspective view showing an exemplary motor vehicle including an energy-absorbing hood assembly having mounted thereto a cushion inner structure according to the present invention;

FIG. 2 is a side-schematic view, in partial cross-section, taken along line 1-1, of a portion of the hood assembly of FIG. 1 having mounted thereto a cushion inner structure in accordance with one embodiment of the present invention;

FIG. 2A is a section plan view of a portion of the energy-absorbing cushion inner structure of FIG. 2, taken along line 2-2;

FIG. 2B is a representative side-schematic view of a portion of the hood assembly with cushion inner structure of FIG. 2 upon initial impact with an object illustrating controlled deformation and failure of a lower layer mounted thereto;

FIG. 2C is a representative side-schematic view of a portion of the hood assembly with cushion inner structure of FIG. 2 shortly after initial impact with an object illustrating controlled deformation and failure of the polyhedral protuberances;

FIG. 3 is a cross-sectional view, taken along line 1-1, of a portion of the hood assembly of FIG. 1 having mounted thereto a cushion inner structure in accordance with an alternate embodiment of the present invention;

FIG. 4 is an isometric perspective view of the hood assembly of FIG. 1 with the upper layer partially broken away to illustrate a cushion inner structure in accordance with another alternate embodiment mounted thereto;

FIG. 5A is a side-schematic view of a portion of the hood assembly of FIG. 3 depicting the energy-absorbing cushion having a multi-layer configuration;

FIG. 5B is a side-schematic view of a portion of the hood assembly of FIG. 3 depicting the energy-absorbing cushion with an acute oblique orientation; and

FIG. 5C is a side-schematic view of a portion of the hood assembly of FIG. 3 depicting the energy-absorbing cushion with a obtuse oblique orientation.

### DESCRIPTION OF THE PREFERRED EMBODIMENTS

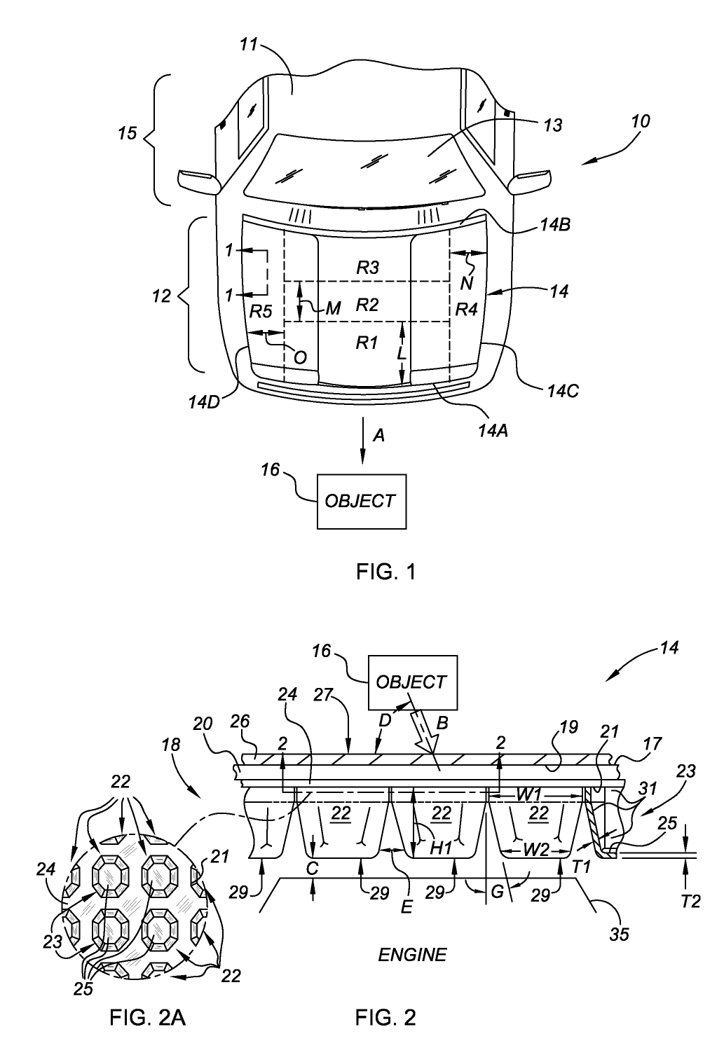

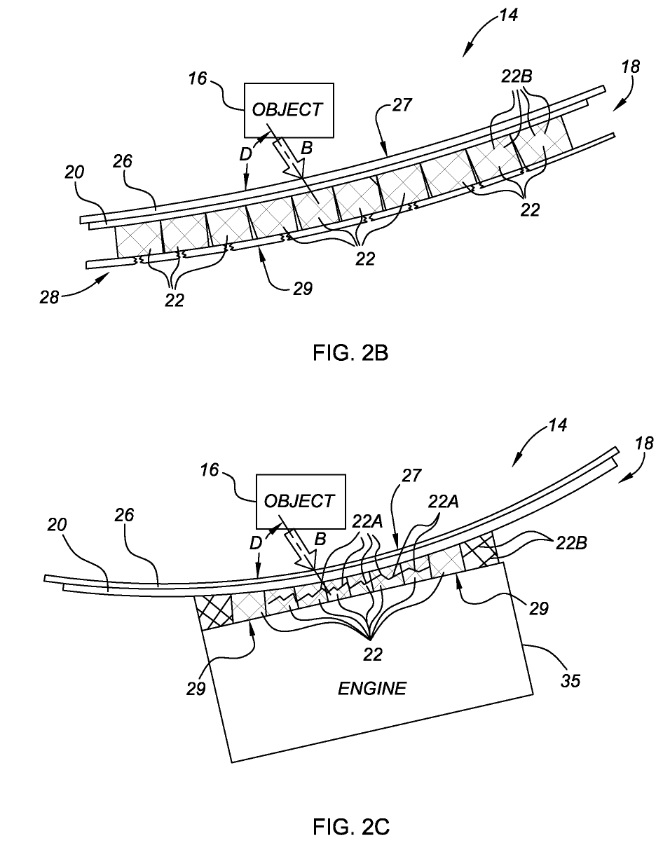

Referring to the Figures, wherein like reference numbers refer to the same or similar components throughout the several views, FIG. 1 is a plan view of an exemplary motor vehicle, identified generally as 10. The vehicle 10 has a vehicle body 11 that includes a moveable or actuatable energy-absorbing vehicle hood assembly 14 having a cushion inner structure, such as cushion structures 18, 118, and 218 of FIGS. 2, 3 and 4, respectively, spanning or covering an engine compartment 12 forward of a passenger compartment 15. Although the vehicle 10 is depicted in FIG. 1 as a standard coupe-type passenger car, the hood assembly 14 can be incorporated into any vehicle platform (e.g., sedan-type passenger cars, light trucks, heavy duty vehicles, etc.)

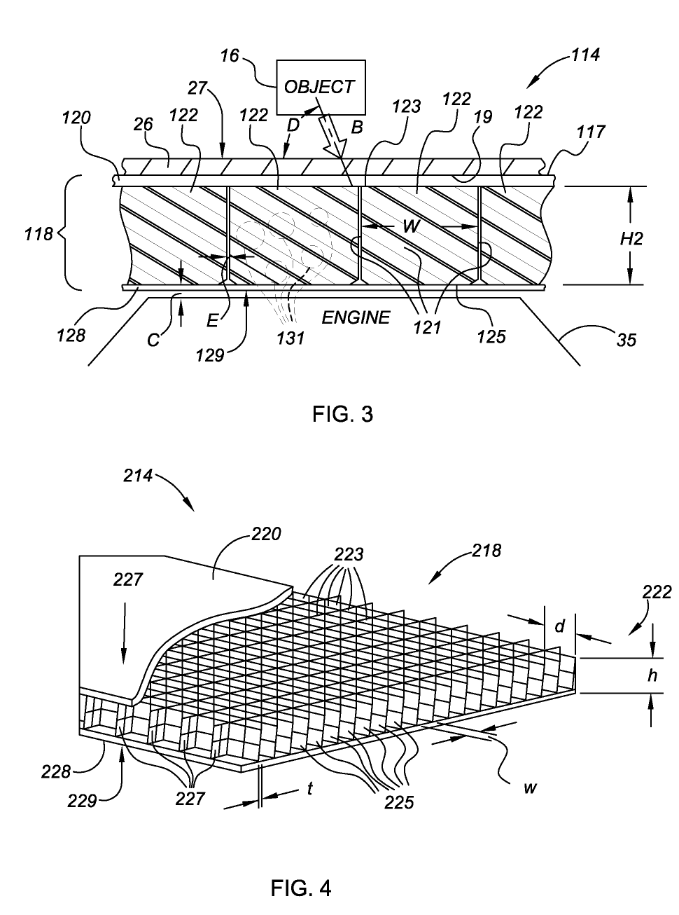

The hood assembly 14 is operatively attached to the vehicle body 11, for example, by one or more peripheral hinges (not shown) positioned adjacent to a windshield 13. Ideally, the hood assembly 14 is sufficiently sized and shaped to provide a closure panel suitable for substantially covering and protecting various vehicular components contained within the engine compartment 12, including, but not limited to, propulsion system components, steering system components, braking system components, and heating, ventilation, and air conditioning (HVAC) system components, all of which are represented collectively herein as engine 35 (see FIGS. 2 and 3.) The term “engine” or “engine compartment” is not considered limiting with respect to the nature or type of propulsion system employed by the vehicle 10. Thus, within the scope of the claimed invention, the vehicle 10 may employ any propulsion system, such as a conventional internal combustion engine, an electric motor, a fuel cell, a hybrid-electric system, etc. As represented in FIG. 1, vehicle 10 may move or travel in the direction of arrow A toward an object 16, positioned external to vehicle 10, in such a manner that the object 16 impacts the hood assembly 14 in a substantially downward direction during a collision therebetween, thereby subjecting the hood assembly 14 to various stresses, forces, and/or loads, as described hereinbelow with reference to FIGS. 2 through 4.

Turning then to FIG. 2, a representative side view of the hood assembly 14, taken along line 1-1 of FIG. 1, is provided to illustrate an energy absorbing cushion inner structure (hereinafter “cushion structure 18”) in accordance with one embodiment of the present invention. The cushion structure 18 includes an upper layer or cover 20, a recessed stratum 24, and preferably a lower layer or inner skin 28 (see FIG. 2B.) The stratum 24 has a plurality of polyhedral cushion protuberances 22 extending substantially perpendicular therefrom. As used herein, the terms “polyhedron” or “polyhedral” are to be defined or interpreted as describing a three-dimensional geometric figure bounded on substantially all sides by polygon faces.

The cushion protuberances 22 are depicted in FIG. 2 as the inner-most members of the hood assembly 14, each including an engine-side surface or “B-surface” 29. The upper layer 20 of the cushion structure 18 is attached, secured, or adhered at a bonding surface 17 to an interior surface 19 of a hood outer panel 26, e.g., by adhesive, fastening, welding, or the like. In contrast to the protuberances 22, the hood outer panel 26 is depicted in FIG. 2 as the outermost member of the hood assembly 14, having a customer-visible “A-surface” 27. Alternatively, the hood outer panel 26 and upper layer 20 can be a single, unitary member, effectively eliminating the bonding and interior surfaces 17, 19.

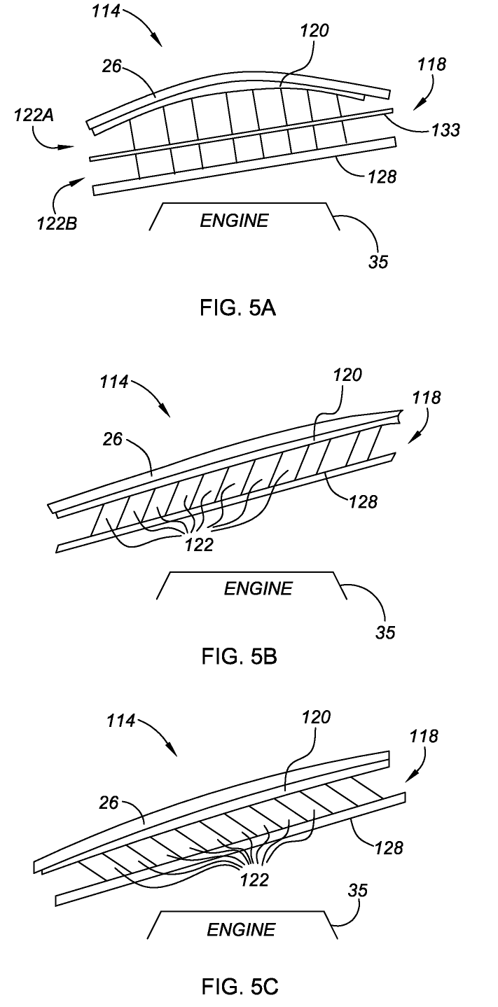

The cushion structure 18 extends so as to cover substantially the entire interior surface 19 of the hood outer panel 26. On the other hand, the cushion structure 18 can be fabricated and secured in such a manner so as to cover only certain portions of the interior surface 19 of the hood outer panel 26. In a similar regard, the cushion structure 18 can comprise a single continuous member, or may be broken into several segments or regions (e.g., regions R1-R5 of FIG. 1) in order to accommodate the curvature of the hood outer panel 26, and performance and packaging constraints caused by the under-hood components (e.g., engine 35.) Finally, as will be described in detail below, the various cushion structure regions R1-R5 can each consist of a single layer or multiple layers (as shown, for example, in FIG. 5A), wherein each region R1-R5 can take on a similar or distinct geometric configuration from the next.

The cushion structure 18 is preferably fabricated entirely from a single plastic material adapted to maintain its integrity under extreme temperatures for optimal performance characteristics, resilience, and ease of manufacture. For example, the cushion structure 18, i.e., upper layer 20, recessed stratum 24, and protuberances 22, are all fabricated from polyphosphate (PP), ploycarbonate (PC), or acrylonitrile-butadiene-styrene terpolymer (ABS resin). Alternatively, the cushion structure 18 may be fabricated from a combination of plastics and/or one or more metallic materials (e.g., cold rolled steel, hot dipped galvanized steel, stainless steel, aluminum, and the like.)

Ideally, the hood outer panel 26 is a one-piece, plate member, preferably finished with an aesthetically appealing, anti-corrosive, highly durable coating (e.g., zinc plating.) It is further preferred that the hood outer panel 26 be fabricated from a material known to have a suitable strength for the intended use of the hood assembly 14. For example, the hood outer panel 26 may be fabricated from a plastic polymer (e.g., PP, PS or ABS), or metal (e.g., cold rolled steel, hot dipped galvanized steel, stainless steel, aluminum, and the like). The hood outer panel 26 may be preformed using such methods as stamping, hydroforming, quick plastic forming, or superplastic forming.

Looking now to both FIGS. 2 and 2A, FIG. 2A provides a sectional plan view of a portion of the energy-absorbing cushion 18, taken along line 2-2 of FIG. 2. The protuberances 22 have a preferably octagonal opening 21 defined by the recessed stratum 24. The periphery of opening 21 is connected to a mostly flat, octagonal base portion 25 by a plurality of side walls 31 to thereby define a cavity, identified generally as 23 (i.e., each protuberance 22 of FIG. 2 is a decahedral polyhedron having a single open plane.) The protuberances 22 are preferably arranged in longitudinal and transverse rows, spaced a distance E from one another, and are of a total number depending upon the desired size and use of the vehicle hood assembly 14. It is also within the scope of the claimed invention that the protuberances 22 take on additional functional geometric configurations, such as, by way of example, a hexahedron (as seen, for example, in FIG. 3) or other polyhedrons, a frusta-cone (not shown), a dome (not shown) and the like, each varying in size and geometric configuration from one to the next. A compressible, energy-absorbing foam material (not shown), such as polyurethane foam, polystyrene foam, and/or other similar materials or combination of such materials may be utilized to fill each cavity 23. Alternatively, the protuberances 22 can be a solid mass (i.e., no cavity 23) fabricated from a brittle plastic, such as Polymethyl methacrylate (PMMA), bulk mold compound (BMC), or the like.

The protuberances 22 have various characteristics, including, but not limited to, structural characteristics and material characteristics. The structural characteristics include, for example, a first width W1 (i.e., the width of the opening 21), a second width W2 (i.e., the width of the base portion 25), a first thickness T1 (i.e., the thickness of the cavity side-walls 31), a second thickness T2 (i.e., the thickness of the base portion 25), a protuberance height H1, a cavity angle G, and a distance E. The material characteristics include, for example, a modulus, yield strength, and a density.

The various structural and material characteristics of the protuberances 22 may be manipulated to provide a predetermined and substantially constant or uniform crush performance for a given threshold crush load. More specifically, with reference to FIGS. 2-2C of the drawings, as the object 16 impacts the A-surface 27 of the hood outer panel 26, the actual and relative mass, velocity, and acceleration of the object 16 and vehicle 10 (see FIG. 1) combine to generate a crush load having a specific magnitude (represented generally by arrow B) in a downward direction, e.g., at an angle D (see FIG. 2.) The characteristics of the cushion structure 18, e.g., first and second widths W1, W2, first and second thicknesses T1, T2, height H1, see FIG. 2, and material properties, e.g., modulus, yield strength, and density, can be selectively modified, individually or collectively, to provide a predetermined initial stiffness, together with the upper layer 20, to generate a substantially large and immediate initial deceleration of the colliding object 16.

Optimally, the cushion structure 18 would replace the structural functions of the inner hood layer (such as lower layer 28 of FIG. 2B) and provide any necessary reinforcement for the hood outer panel 26. For example, the cushion structure 18, together with an adhesive (not shown), acts as an added mass to the hood assembly 14, the inertial effect of such added mass promoting deceleration of the object 16 in the early stages of the vehicle-object collision. However, inner hood layer 28, FIG. 2B, may be included in the embodiment of FIG. 2 to provide additional reinforcement and support for the hood assembly 14.

Looking now at FIG. 2B, the cushion structure 18, besides adding to the initial stiffness of the hood assembly 14, is designed to trigger local rupture or failure of the lower layer 28 during the initial impact of the object 16 with the hood assembly 14. For example, deformation of the hood outer panel 26 during collision with an object 16 may induce a deliberate breakdown of the adhesive (not shown) holding the cushion structure 18 to the hood outer panel 26. The cushion structure 18 is thereafter designed to trigger local deformation (e.g., bending, buckling, or compression) and/or rupture of the lower layer 28 (depicted symbolically in FIG. 2B by the fractured lower layer 28) at a first predetermined threshold crush load resulting from the impact of the object 16 with the under-hood components (e.g., engine 35.) The local rupture of the lower layer 28 can selectively and controllably reduce the local and global stiffness of the hood assembly 14, resulting in increased absorption of the kinetic energy transferred from the object 16 to the hood assembly 14, thereby maximizing any consumed under-hood space (e.g., reducing the clearance C of FIG. 2 between the engine 35 and B-surface 29 required to stop the object 16.) Failure of the lower layer 28 can be manipulated by, for example, the addition of pre-cuts or inclusions thereto (not shown herein.)

Referring to FIG. 2C, the protuberances 22 also serve as padding in the form of controlled failure of the individual protuberance 22 mini-structures, to absorb residual kinetic energy from the object 16 upon impact with the under-hood components (e.g., engine 35.) By way of example, the sidewalls 31 controllably compress at a second predetermined threshold crush load, as shown in FIG. 2C, upon contact with any of the various under-hood components (e.g., engine 35). The cushion structure 18 may also be configured to trigger local rupture of the protuberances 22 (depicted symbolically in FIG. 2C by fracture lines 22A.) Deformation and/or rupture of the protuberances 22 can be manipulated by, for example, the addition of pre-cuts or inclusions thereto (depicted generally as 22B in FIG. 2B.) In effect, the opposing force imparted to the object 16 by the hood assembly 14 upon a collision therebetween is relatively less variable, and provides a larger initial attenuation of kinetic energy resulting in a reduced residual velocity. This in turn reduces the total distance of travel required by a decelerating object 16 in order for the hood assembly 14 to fully absorb the energy from such a collision, thereby minimizing or eliminating contact between the object 16 and any under-hood components (e.g., engine 35).

The hood outer panel 26 (and/or upper layer 20) may also be engineered, by virtue of its geometry and elasticity, to have a relatively high tensile and compressive strength or stiffness to provide a preferred performance, while still maintaining a relatively low failure or threshold crush strength permitting a particular failure response or crush performance when the hood assembly 14 is subjected to crush load B, i.e. when the crush load B exceeds the threshold crush strength of hood outer panel 26. Ideally, the threshold crush strength is set at a level sufficient to permit contact with various small stones, hail, minor debris, or other such representative objects commonly encountered during ordinary roadway operation, to enable the hood assembly 14 to be utilized in a wide range of driving conditions without fracturing or failing.

According to FIG. 1, the hood assembly 14 is preferably broken up into five regions R1-R5, respectively. The first R1, second R2, and third R3 regions divide the hood assembly 14 into a forward region, a middle region, and a rearward region, respectively. In other words, the first region R1 extends from a forward edge 14A of the hood assembly 14 to a distance M extending rearward along the vehicle body 11. In addition, the second region R2 extends from the distance L rearward along the vehicle body 11 a further distance M. The third region R3 extends from the distance M (i.e., a distance L+M from the forward edge 14A of the hood assembly 14) to a rearward edge 14B, as depicted in FIG. 1. The fourth R4 and fifth R5 regions, if included, further dissect the hood assembly 14 into one or more lateral segments. For example, the fourth region R4 extends inward a distance N from a right lateral edge 14C of the hood assembly 14, whereas the fifth region R5 extends inward a distance 0 from a left lateral edge 14D, also illustrated in FIG. 1. Notably, the dimensions shown in FIG. 1 for regions R1 through R5 are merely exemplary and provided for descriptive purposes, i.e., the length and width of the five regions R1-R5 may vary infinitely. Furthermore, a single region may be utilized or more than five regions may be employed, each having identical or differing geometric configurations, without departing from the scope of the claimed invention.

The cushion structure 18 is optimized for each respective region R1-R5 independently of the other for impact with objects of varying dimensions and masses in order to maintain a clearance C of preferably less than 85 mm while still meeting all crush performance requirements. Put another way, the various protuberance 22 characteristics e.g., first and second widths W1, W2, first and second thicknesses T1, T2, height H1, see FIG. 2, and material properties—modulus, yield strength, and density, are engineered for each respective region R1-R5 to meet varying performance and packaging requirements for each region R1-R5.

Referring now to FIG. 3, there is shown in full cross-section a portion of a vehicle hood assembly 114 having an energy-absorbing cushion inner structure 118 in accordance with an alternate embodiment of the present invention mounted thereto. The cushion structure 118 includes an upper layer or outer skin 120, a lower layer or inner skin 128, and a plurality of polyhedral cushion protuberances 122 therebetween. The lower layer 128, depicted in FIG. 3 as the inner-most member of the hood assembly 114 (i.e., closest to the engine block 35), includes an engine-side surface or “B-surface” 129. In contrast to the lower layer 128, the hood outer panel 26 is depicted as the outermost member, having a customer-visible “A-surface” 27. The upper layer 120 of the cushion structure 118 is attached, secured, or adhered at a bonding surface 117 to an interior surface 19 of the hood outer panel 26. Similar to the embodiment of FIG. 2, the hood outer panel 26 and upper layer 120 can alternatively be a single, unitary member.

The cushion structure 118 may extend so as to cover substantially the entire interior surface 19 of the hood outer panel 26, or be fabricated and secured in such a manner so as to cover only certain portions of the interior surface 19. Functioning in a similar fashion as the cushion structure 18 of FIG. 2, the cushion structure 118 of FIG. 3 can comprise a single continuous region, or may be broken into several individual segments or regions (e.g., regions R1-R5 of FIG. 1) in order to accommodate the curvature of the hood outer panel 26, and performance and packaging constraints caused by under-hood components (e.g., engine 35). To this regard, the structural characteristics, configuration, orientation, and material properties may be selectively modified for each region, tailored to meet performance requirements for that particular location (e.g., to accommodate hard-spots, smaller clearances, larger under-hood components, etc.) It is also considered within the scope of the claimed invention to increase the height H2 of the protuberances 122 to thereby eliminate the clearance C between the B-Surface 129 of the lower layer 128 and the engine 35 (or other under-hood components) in one or more regions.

The upper and lower layers 120, 128 may be fabricated entirely from metal, entirely from plastic, or a combination thereof. For example, the upper and lower layers 120, 128 may each be fabricated from a brittle plastic, such as PMMA or BMC, or from a metallic material, such as cold rolled steel, hot dipped galvanized steel, stainless steel, aluminum, and the like, of similar or varying thicknesses. Ideally, the upper and lower layers 120, 128 are one-piece, plate members preferably preformed using such methods as stamping, hydroforming, quick plastic forming, or superplastic forming. It is further preferred that the upper and lower layers 120, 128 be individually contoured—e.g., the upper layer 120 is preformed with contours for aesthetic appeal and/or for improved bonding to the interior surface 19 of the hood outer panel 26, while the lower layer 128 is preformed with differing geometric parameters to meet certain packaging and performance constraints. It is also within the scope of the present invention that the upper and lower layers 120, 128 each consists of multiple plate members, include rounded or beveled edges and corners, have varying geometric configurations, and/or be identically contoured.

According to the embodiment of FIG. 3, the protuberances 122 have a substantially hexahedral geometric configuration, having four side-walls 121 (only three of which are identifiable in FIG. 3), a top face 123, and a base portion 125. Similar to the embodiment of FIG. 2, the protuberances 122 of FIG. 3 extend substantially perpendicular from the upper surface 120, and are preferably arranged in longitudinal and transverse rows, spaced a distance E from one another. The total number of protuberances 122 depends upon the desired size and use of the vehicle hood assembly 114. Unlike the embodiment of FIG. 1, the protuberances 122 of FIG. 3 are preferably solid (e.g., continuous) high-temperature, high-performance polymer foam or rubber padding (e.g., saturated copolymer rubber, ethylene-propylene-type rubber (EPDM), and the like.) Rather than being homogenously solid, the protuberances 122 can include one or more fluid pockets, shown generally as hidden lines 131, of similar or varying geometries. To this regard, the pockets 131 are filled with fluid (e.g., air) or a compressible, energy-absorbing foam material (e.g., polyurethane, polystyrene, or other similar materials or combination of such materials.)

Each protuberance 122 possesses various characteristics, including, but not limited to, a wall width W, wall height H, modulus, yield strength, and density. Similar to the embodiment of FIG. 2, the various characteristics of the protuberances 122 of FIG. 3 may be selectively modified, individually or collectively, to provide a predetermined and substantially constant or uniform crush performance for a given threshold crush load. Similarly, each of the respective upper and lower layers 120, 128 may be engineered, by virtue of their individual geometries, to have a relatively high predetermined tensile and compressive strength, while still maintaining a relatively low threshold crush strength permitting a particular crush performance when the hood assembly 114 is subjected to a crush load, i.e. crush load B.

Still referring to FIG. 3, the cushion structure 118 is configured to provide sufficient initial stiffness together with the hood outer panel 26 to generate a large initial deceleration as soon and high as possible upon impact with object 16. In one instance, the cushion structure 118, together with an adhesive (not shown), acts as a uniformly distributed, added mass to the hood assembly 114—the inertial effect promoting deceleration of the object 16 in the early stages of a vehicle-object collision. When the object 16 presses downwards, e.g., at an angle D, the hood assembly 114, namely B-surface 129 of lower layer 128 or, in embodiments wherein the lower layer 128 is eliminated, the base portion 125 of the protuberances 122, may contact the under-hood components (e.g., engine 35.) The plurality of protuberances 122 responsively compress and deform to thereby provide an energy absorbing channel. It is undesirable in this scenario for the protuberances 122 to break or fall off. Accordingly, the width W and height H should be maintained at a sufficient ratio, or a variety of pre-cuts (e.g., precuts or inclusions 22B of FIGS. 2A and 2B) should be added, to control and/or eliminate any premature fracturing or failure of the protuberances 122.

The cushion structure 118, besides adding to the initial stiffness of the hood assembly 114, is designed to trigger local rupture or failure of the lower layer 128 during the initial impact of the object 16 with the hood assembly 114. The local ruptures, can selectively and controllably reduce the local and global stiffness of the hood assembly 114, resulting in increased absorption of the kinetic energy transferred from the object 16 to the hood assembly 114, thereby minimizing consumed under-hood space (i.e., clearance C between the engine 35 and B-surface 129.) Failure of the lower layer 128 can be manipulated by, for example, the addition of pre-cuts or inclusions (not shown) to the lower layer 128. Furthermore, the lower layer 128 supports the cushion structure 118 to provide the necessary bending stiffness during the initial impact between the hood assembly 114 and object 16. In other words, the hood assembly 114 is able to meet stringent performance requirements (i.e., maintain sufficient stiffness and inertia effect) with a minimal height H through the combination of the hood outer panel 26 with the cushion structure 118, thereby minimizing the clearance C between the engine 35 (or other under-hood components) and the lower layer B-surface 129 of the hood assembly 114. In effect, the opposing force imparted to the object 16 by the hood assembly 114 upon a collision therebetween is relatively less variable, provides a larger initial attenuation of kinetic energy resulting in a reduced residual velocity. This in turn reduces the total distance of travel required by a decelerating object 16 in order for the hood assembly 114 to fully absorb the energy from such a collision, minimizing and mitigating contact between the object 16 and any under-hood components (e.g., engine 35).

FIG. 4 offers an isometric perspective view of a portion of a vehicle hood assembly 214 partially broken away to illustrate an energy-absorbing cushion inner structure 218 according to an alternate embodiment of the present invention. The cushion structure 218 includes an upper layer 220, a lower layer 228, and a rectangular-celled honeycomb cushion 222 therebetween. The lower layer 228 is intended as the inner-most member of the hood assembly 214, including an engine-side “B-surface” 229. In contrast, the upper layer 220 is intended as the outermost member, having a customer-visible “A-surface” 227.

Alternatively, the cushion structure 218 can be attached, secured, or adhered to an outer hood panel (such as hood outer panel 26 of FIGS. 1-3.) In this regard, the cushion structure 218 of FIG. 4 may extend so as to cover substantially the entire under side of the outer hood panel, e.g., interior surface 17 of hood outer panel 26 of FIGS. 1-3, or be fabricated and secured in such a manner so as to cover only certain portions of the under side. Moreover, the cushion structure 218 can comprise a single continuous region, or may be broken into several individual segments (e.g., regions R1-R5 of FIG. 1) to meet predetermined performance and packaging constraints.

Ideally, the honeycomb cushion 222 of FIG. 4 is of the same length and width as the upper and lower layers 220, 228, fabricated from a material known to have a suitable strength for the intended use of the hood assembly 214. The cushion structure 218 is preferably a one-piece structure, fabricated entirely from a single plastic material adapted to maintain its integrity under extreme temperatures for optimal performance characteristics, resilience, and ease of manufacture. For example, both the upper and lower layers 220, 228, and the honeycomb cushion 222, are all fabricated by known processes from one of PP, PC, or ABS resin. Alternatively, the cushion structure 218 may be fabricated from a combination of plastics and/or one or more metallic materials.

Synonymous to the upper and lower layers 120, 128 of FIG. 3, the upper and lower layers 220, 228 are preferably one-piece, plate members that are individually contoured—e.g., the upper layer 220 is preformed with contours for aesthetic appeal, while the lower layer 228 is preformed with differing geometric parameters to meet certain predetermined packaging and performance constraints. It is also within the scope of the claimed invention that the upper and lower layers 220, 228 each consists of multiple plate members, include rounded or beveled edges and corners, have complementary geometric configurations, and be fabricated separately from the honeycomb cushion 222.

Still referring to FIG. 4, the honeycomb cushion 222 comprises a plurality of preferably polyhedral ducts 223 defined by a of plurality longitudinal 225 and transverse 227 partition walls, and extending substantially orthogonally from the upper surface 220 towards the lower surface 228. As seen in FIG. 4, the ducts 223 are arranged in longitudinal and transverse rows, and are a total number depending upon the desired size and use of the vehicle hood assembly 214.

The honeycomb cushion 222 possess various structural characteristics, i.e., a wall depth d, wall height h, wall thickness t, and wall width w, and various material properties, i.e., modulus, yield strength, and density. Synonymous with the embodiments of FIGS. 2 and 3, the various characteristics of the honeycomb cushion 222 of FIG. 4 may be selectively modified, individually or collectively, to provide a predetermined and substantially constant or uniform crush performance for a given threshold crush load. Similarly, each of the respective upper and lower layers 220, 228 may be engineered, by virtue of their individual geometries, to have a relatively high predetermined tensile and compressive strength, while still maintaining a relatively low threshold crush strength permitting a particular crush performance when the hood assembly 214 is subjected to a crush load, i.e. crush load B.

FIGS. 5A through 5C illustrate alternate embodiments of the present invention that function similarly to the previously described vehicle hood assemblies 14, 114 and 214 of FIGS. 2-4, respectively, but include, among other things, variations in the configuration and orientation of the energy-absorbing cushion inner structure. For simplicity and brevity, the proposed variations will be described with respect to the embodiment of FIG. 3, although applicable to any embodiment within the scope of the claimed invention described herein. Furthermore, the embodiments depicted in FIGS. 5A-5C, like FIGS. 1-4, are not to scale and are provided purely for clarification purposes; thus, the particular dimensions of the drawings presented herein are not to be considered limiting.

FIG. 5A is intended primarily to illustrate that the energy-absorbing cushion inner structures 18, 118, and 218 of the present invention may be multi-layered. More specifically, a side schematic view of the hood assembly 114 of FIG. 3 is provided, wherein the cushion structure 118 includes a first plurality of polyhedral protuberances 122A extending from the upper layer 120, and second plurality of polyhedral protuberances 122B, extending from a middle layer 133, wherein the first and second layers of protuberances 122A, 122B are disposed between the upper layer 120 and lower layer 128.

FIGS. 5B and 5C are provided primarily to illustrate that the energy-absorbing cushion inner structures 18, 118, and 218 of the present invention may be oriented in a various manners. More specifically, FIG. 5B is a side-schematic view of the hood assembly 114 of FIG. 3 depicting the energy-absorbing cushion 118 wherein the polyhedral protuberances 122 are arranged with a substantially acute oblique orientation from the upper surface 120. Alternatively, FIG. 5C is a side-schematic view of the hood assembly 114 of FIG. 3 depicting the energy-absorbing cushion 118 wherein the protuberances 122 are arranged with a substantially obtuse oblique orientation from the upper surface 120. The angle of orientation (e.g., acute oblique of FIG. 5B or obtuse oblique of FIG. 5C) can be selectively modified to manipulate the primary mode of deformation (e.g., buckling, bending, fracturing) or the combination of modes of deformation of the cushion structures 18, 118 and 218 of FIGS. 2-4, respectively.

While the best modes for carrying out the invention have been described in detail, those familiar with the art to which this invention relates will recognize various alternative designs and embodiments for practicing the invention within the scope of the appended claims.

1. An energy-absorbing hood assembly for use with a motorized vehicle having a front compartment adapted to house under-hood components, the hood assembly configured to extend over and above the front compartment, comprising:
an upper layer having substantially opposing first and second surfaces; and
a plurality of polyhedral protuberances operatively attached to and extending from said second surface of said upper layer;
wherein said plurality of polyhedral protuberances are adapted to absorb and attenuate crush loads imparted to the hood assembly as a result of impact between an object and the hood assembly; and
wherein said plurality of polyhedral protuberances are adapted to absorb and attenuate resultant forces imparted to the object by the under-hood components as a result of impact between the object and the hood assembly.

2. The hood assembly of claim 1, further comprising:
a lower layer having substantially opposing third and fourth surfaces, wherein said plurality of polyhedral protuberances being disposed between said second surface of said upper layer and said third surface of said lower layer.

3. The hood assembly of claim 1, further comprising:
a hood outer panel having an interior surface, wherein said first surface of said upper layer is operatively secured to said interior surface of said hood outer panel.

4. The hood assembly of claim 1, wherein said plurality of polyhedral protuberances defines a first set of structural and material characteristics along a first region of the hood assembly, said first set of structural and material characteristics being selectively configured to provide a first predetermined level of absorption and attenuation of said resultant forces and said crush loads.

5. The hood assembly of claim 4, wherein said plurality of polyhedral protuberances further defines a second set of structural and material characteristics along a second region of the hood assembly different from said first region, said second set of structural and material characteristics being selectively configured to provide a second predetermined level of absorption and attenuation of said resultant forces and said crush loads.

6. The hood assembly of claim 5, wherein said plurality of polyhedral protuberances further defines a set of variable structural and material characteristics along a third region of the hood assembly different from said first and second regions, said set of variable structural and material characteristics being configured to provide varying levels of absorption and attenuation of said resultant forces and said crush loads throughout said third region.

7. The hood assembly of claim 2, wherein said upper layer, lower layer, and polyhedral protuberances are each made from one of a metallic material, a brittle plastic, a high-temperature, high-performance polymer foam, and rubber padding.

8. The hood assembly of claim 7, wherein said plurality of polyhedral protuberances each have a decahedral configuration.

9. The hood assembly of claim 7, wherein said plurality of polyhedral protuberances defines a rectangular-celled honeycomb structure.

10. The hood assembly of claim 7, wherein said plurality of polyhedral protuberances each have a hexahedral configuration.

11. The hood assembly of claim 2, wherein said lower layer is configured to controllably fail at a predetermined threshold crush load imparted to the hood assembly by the object upon impact therebetween.

12. The hood assembly of claim 11, wherein said lower layer is configured to controllably fail at said predetermined threshold crush load via the addition of precuts or inclusions thereto.

13. The hood assembly of claim 1, wherein said plurality of polyhedral protuberances are each configured to controllably deform at a predetermined threshold crush load imparted to the hood assembly by an object upon impact therebetween.

14. The hood assembly of claim 13, wherein said plurality of polyhedral protuberances are each configured to controllably deform at said predetermined threshold crush load via the addition of precuts or inclusions thereto.

15. The hood assembly of claim 1, wherein said plurality of polyhedral protuberances extends substantially perpendicular from said second surface of said upper layer.

16. The hood assembly of claim 1, wherein said plurality of polyhedral protuberances extends in a substantially acute oblique orientation from said second surface of said upper layer.

17. The hood assembly of claim 1, wherein said plurality of polyhedral protuberances extends in a substantially obtuse oblique orientation from said second surface of said upper layer.

18. The hood assembly of claim 1, wherein said plurality of polyhedral protuberances are arranged in at least one longitudinal row and at least one transverse row.

19. The hood assembly of claim 1, further comprising:
a middle layer having opposing fifth and sixth surfaces, wherein said plurality of polyhedral protuberances are also operatively attached to and extending from said sixth surface of said middle layer.

20. A hood assembly for use with a motorized vehicle, comprising:
an upper layer including a first surface substantially opposing a second surface having a plurality of polyhedral protuberances extending outward therefrom; and
a lower layer having substantially opposing third and fourth surfaces, wherein said plurality of polyhedral protuberances are disposed between said second and said third surfaces and arranged in at least one longitudinal and at least one transverse row;
wherein said lower layer is configured to controllably fail at a first predetermined threshold crush load imparted to the hood assembly by an object upon impact therebetween; and
wherein said plurality of polyhedral protuberances are each configured to controllably deform at a second predetermined threshold crush load imparted to the hood assembly by an object upon impact therebetween.

21. The hood assembly of claim 20, wherein said upper layer, lower layer, and plurality of polyhedral protuberances are each made from one of a metallic material, a brittle plastic, a high-temperature, high-performance polymer foam, and rubber padding.

22. The hood assembly of claim 21, wherein said plurality of polyhedral protuberances defines a first set of structural and material characteristics along a first region of the hood assembly, said first set of structural and material characteristics being selectively configured to provide a first predetermined level of absorption and attenuation of kinetic energy imparted to the hood assembly by the object upon impact therebetween.

23. The hood assembly of claim 22, wherein said plurality of polyhedral protuberances further defines a second set of structural and material characteristics along a second region of the hood assembly, said second set of structural and material characteristics being selectively configured to provide a second predetermined level of absorption and attenuation of kinetic energy imparted to the hood assembly by the object upon impact therebetween.

24. The hood assembly of claim 23, wherein said plurality of polyhedral protuberances further defines a set of variable structural and material characteristics along a third region of the hood assembly, said set of variable structural and material characteristics being selectively configured to provide varying levels of absorption and attenuation of kinetic energy imparted to the hood assembly by the object upon impact therebetween throughout said third region.

25. The hood assembly of claim 24, further comprising:
a hood outer panel having an interior surface, wherein said first surface of said upper layer is operatively secured to said interior surface of said hood outer pane.

26. The hood assembly of claim 25, wherein said plurality of protuberances each have a decahedral configuration.

27. The hood assembly of claim 25, wherein said plurality of protuberances each have a hexahedral configuration.

28. The hood assembly of claim 25, wherein said plurality of protuberances defines a rectangular-celled honeycomb structure.

29. The hood assembly of claim 25, wherein said plurality of polyhedral protuberances extends substantially perpendicular from said second surface of said upper layer.

30. The hood assembly of claim 25, wherein said plurality of polyhedral protuberances extends in a substantially oblique orientation from said second surface.

31. A vehicle having a vehicle body defining a front compartment, the vehicle comprising:
a hood assembly configured to extend over and above the front compartment of the vehicle, said hood assembly including:
an upper layer having substantially opposing first and second surfaces;
a lower layer having substantially opposing third and fourth surfaces; and
a plurality of polyhedral protuberances operatively attached to and extending from said second surface of said upper layer, disposed between said second and third surfaces;
wherein said plurality of polyhedral protuberances defines a first set of structural and material characteristics along a first region of said hood assembly; and
wherein said plurality of polyhedral protuberances further defines a second set of structural and material characteristics along a second region of said hood assembly different from said first region, said first and second sets of structural and material characteristics each being selectively configured to provide different predetermined levels of absorption and attenuation of kinetic energy imparted to said hood assembly by an object upon impact therebetween.

32. The vehicle of claim 31, wherein said lower layer is configured to controllably fail at a first predetermined threshold crush load imparted to the hood assembly by the object upon impact therebetween, and said plurality of polyhedral protuberances are configured to controllably deform at a second predetermined threshold crush load imparted to the hood assembly by the object upon impact therebetween.

33. The vehicle of claim 32, wherein said upper layer, lower layer, and plurality of polyhedral protuberances are each made from one of a metallic material, a brittle plastic, a high-temperature, high-performance polymer foam, and rubber padding.

34. The vehicle of claim 33, wherein said plurality of protuberances each have a decahedral configuration.

35. The vehicle of claim 33, wherein said plurality of protuberances each have a hexahedral configuration.

36. The vehicle of claim 33, wherein said plurality of protuberances defines a rectangular-celled honeycomb structure.

37. The vehicle of claim 33, further comprising:
a hood outer panel having an interior surface, wherein said first surface of said upper layer is operatively secured to said interior surface of said hood outer panel.

38. The vehicle of claim 33, further comprising:
a middle layer having opposing fifth and sixth surfaces, wherein said plurality of polyhedral protuberances are also operatively attached to and extending from said sixth surface of said middle layer, disposed between said second and third surfaces.
